(19) United States
(12) Patent Application Publication
(10) Pub. No.: US 2026/0356104 A1
(43) Pub. Date: Nov. 12, 2026

(54) IMAGE FORMING APPARATUS

(71) Applicant: CANON KABUSHIKI KAISHA, Tokyo (JP)

(72) Inventor: AKIRA MATSUMOTO, Ibaraki (JP)

(21) Appl. No.: 19/666,021

(22) Filed: May 1, 2026

(30) Foreign Application Priority Data
May 7, 2025 (JP) 2025-077644

(51) Int. Cl. B41J 11/00; B41J 13/08; B41J 25/308; B41J 29/13

(52) U.S. Cl. CPC B41J 11/0085; B41J 11/006; B41J 13/08; B41J 25/308; B41J 29/13

(57) ABSTRACT

An image forming apparatus includes a conveyance belt; a head provided to face the conveyance belt; a suction unit provided inside the conveyance belt; a door configured to be opened and closed; a detection unit configured to detect opening and closing of the door; and a control unit configured to control driving of the suction unit, wherein in a case where driving of the conveyance belt is stopped due to occurrence of a conveyance jam, the control unit controls the driving of the suction unit based on a detection result from the detection unit so as to continue the driving of the suction unit until the door is transitioned from an open state to a closed state, and stop the driving of the suction unit in a case where the door is transitioned from the open state to the closed state.

### BACKGROUND

### Field of the Technology

The present disclosure relates to an image forming apparatus including a conveyance belt that conveys a sheet to a position facing a print head that ejects ink.

### Description of the Related Art

There is a known image forming apparatus including a print head that ejects ink, and a print belt that is disposed to face the print head and conveys sheets. In the image forming apparatus, the surface of the print belt may undulate due to driving, or a sheet may lift from the print belt and fail to be conveyed integrally with the print belt. It is known that such undulation of the print belt and lifting of the sheet from the print belt make it difficult to eject ink onto the sheet with high accuracy. To address this, the print belt and a sheet are sucked from below the print belt using fans or the like, preventing the print belt from undulating and the sheets from lifting from the print belt.

When a conveyance jam occurs in the image forming apparatus, the conveyance of the sheet within the image forming apparatus and printing using the print head are stopped. In this case, the sheet may remain on the print belt, and thus, it is necessary to remove the sheet remaining in the image forming apparatus to resume the printing. The remaining sheet is an unfixed sheet with a printed image not yet fixed by a fixing device on the downstream side. If this unfixed sheet lifts from the print belt and comes into contact with the print head, there is a possibility that the print head may be contaminated, leading to malfunction of the print head.

Japanese Patent No. 4611318 describes a configuration of, when a conveyance jam occurs, lowering a print belt unit to a predetermined position while the unfixed sheet is being sucked and attracted on the print belt. It is also described that the suction by fan is stopped in response to the print belt unit being lowered to the predetermined position, facilitating the removal of the jammed sheet by the user. Further, instead of stopping the fan, Japanese Patent No. 4611318 describes a configuration of weakening the suction by the fan with driving of the fan being continued in response to the print belt unit being lowered to the predetermined position.

However, in the configuration described in Japanese Patent No. 4611318, in which the fan is stopped before removal of a jammed sheet, there is a possibility that an unfixed sheet may lift from the print belt, leading to contamination of the print head or the inside of the image forming apparatus. Further, the configuration in which the suction by the fan is continued even after the removal of the jammed sheet is not desirable in view of energy saving.

### SUMMARY

The present disclosure is directed to providing an image forming apparatus capable of reducing unnecessary power consumption while an unfixed sheet is prevented from lifting from a print belt at the time of jam clearance.

According to some embodiments of the present disclosure, an image forming apparatus includes a conveyance belt configured to convey a recording material while sucking, a head provided to face the conveyance belt and configured to eject ink to the recording material being conveyed by the conveyance belt to form an image, a suction unit provided inside the conveyance belt and configured to suck air to attract the recording material onto a surface of the conveyance belt, a door configured to, in a case where the recording material remains on the surface of the conveyance belt due to a conveyance jam, be opened and closed for the recording material remaining on the surface of the conveyance belt to be removed, a detection unit configured to detect opening and closing of the door, and a control unit configured to control driving of the suction unit, wherein in a case where driving of the conveyance belt is stopped due to occurrence of the conveyance jam, the control unit controls the driving of the suction unit based on a detection result from the detection unit so as to continue the driving of the suction unit until the door is transitioned from an open state to a closed state, and stop the driving of the suction unit in a case where the door is transitioned from the open state to the closed state.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a hardware configuration of an image forming apparatus.

FIGS. 2A and 2B are diagrams each illustrating a system configuration of the image forming apparatus.

FIGS. 3A and 3B are each a view for describing movement of a print head and a print head cap.

FIGS. 4A - 4D are views for describing door locking and door status detection of a print unit.

FIGS. 5A - 5E are views illustrating behavior when a conveyance failure occurs.

FIG. 6 is a flowchart according to some embodiments.

### DESCRIPTION OF THE EMBODIMENTS

Various exemplary embodiments, features, and aspects to implement the present disclosure will now be described with reference to the drawings.

### FIRST EMBODIMENT

### Overview

In an image forming apparatus described as a first embodiment of the present disclosure, when a print belt is being driven, the print belt is sucked from below using suction fans. In a normal state, when the print belt is stopped, the suction fans are also stopped. On the other hand, when the print belt is stopped due to a conveyance failure (in a case where an unfixed sheet remains on the print belt), the print belt is stopped, but the suction fans continue to operate. This prevents the unfixed sheet remaining on the print belt from lifting from the print belt. Then, after the unfixed sheet is removed from the print belt, the suction is stopped.

The present embodiments will now be described in detail with reference to the drawings.

### Hardware Configuration of Image Forming Apparatus

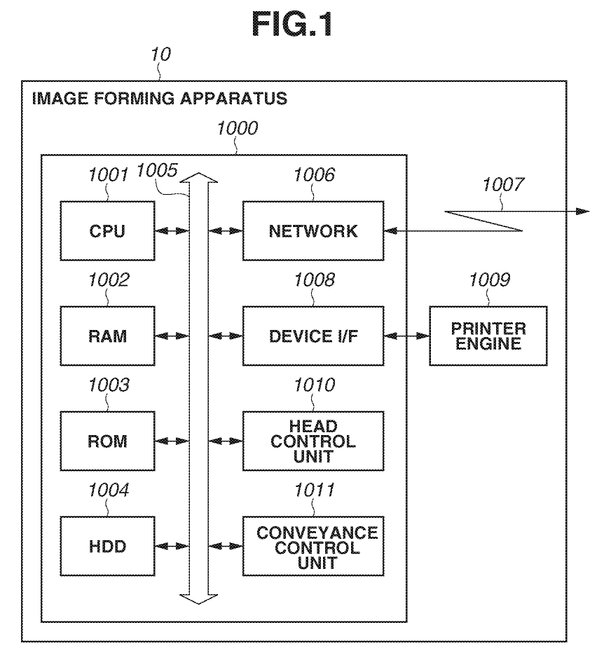

FIG. 1 is a hardware block diagram of an image forming apparatus 10 according to the present embodiments. A controller unit 1000 controls the input and the output of sensor signals and device information. A program in which processing details according to the present embodiments are described is stored in a read-only memory (ROM) 1003 or a hard disk drive (HDD) 1004, and installed in the image forming apparatus 10. A central processing unit (CPU) 1001 as a control unit reads the program stored in the ROM 1003 or the HDD 1004 into a random-access memory (RAM) 1002 to execute the program. Further, the CPU 1001 generally controls each device connected to a system bus 1005. The RAM 1002 functions as a main memory and a working memory of the CPU 1001. The ROM 1003 stores a boot program to be executed at power-on, and the HDD 1004 stores an operating system and a main body of a control program for the image forming apparatus 10. Further, the HDD 1004 is also used to store large-capacity data temporarily or for a long-term. A network 1006 is connected to a local area network 1007, and is configured to input and output data and device information to and from an external device. Alternatively, a program can be installed in the ROM 1003 or the HDD 1004 via the network 1006. A device interface (I/F) 1008, which is an interface unit with a printer engine 1009, inputs and outputs signals for operating and referring to various motors, sensors, inkjet heads, and the like connected to the printer engine 1009. The printer engine 1009 is an inkjet-type output device that conveys a print sheet under load control from the controller unit 1000 and controls an inkjet head to output an image onto the print sheet.

A conveyance control unit 1011 is configured to control conveyance motors and sensors from feeding each print sheet to discharging the print sheet to the outside of the image forming apparatus 10.

A head control unit 1010 controls the inkjet head included in the printer engine 1009 via the device I/F 1008, and is configured to perform ink ejection control for image formation in synchronization with a timing at which a sheet reaches the ejection position of the inkjet head.

### Configuration Diagram of Image Forming Apparatus

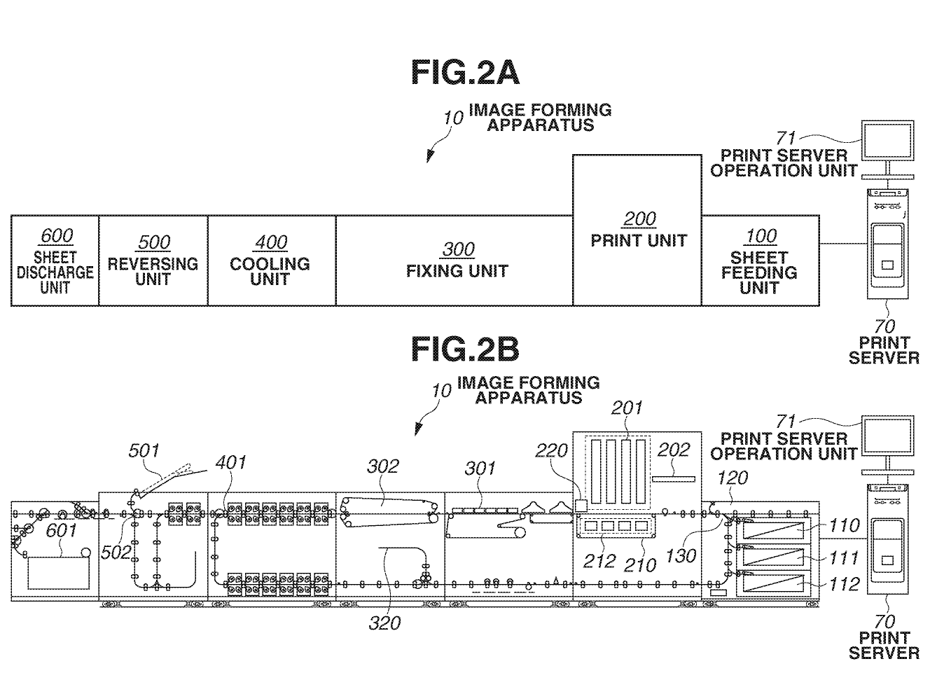

FIGS. 2A and 2B each illustrate an example of a configuration of the image forming apparatus 10 according to the present disclosure.

FIG. 2A is a conceptual diagram illustrating each unit included in the image forming apparatus 10 according to the present embodiments. The image forming apparatus 10 includes six units, namely, a sheet feeding unit 100, a print unit 200, a fixing unit 300, a cooling unit 400, a reversing unit 500, and a sheet discharge unit 600. A print server 70, which is connected to the image forming apparatus 10 via the network 1006, changes various settings, transmits a print job, or the like to operate the image forming apparatus 10. The change of various settings or the transmission of the print job is performed by an operation via a user interface (UI) screen displayed on a print server operation unit 71 connected to the print server 70. An instruction to perform door unlocking, which will be described below, is also issued via the UI screen.

The sheet feeding unit 100 includes sheet feeding cassettes, namely, three sheet feeding cassettes 110, 111, and 112 that store various types of print sheets used in print processing. Further, the sheet feeding unit 100 has a sheet discharge port 120 for temporarily retracting a print sheet that is not affected by a conveyance failure when the conveyance failure occurs. The sheet feeding unit 100 also includes a conveyance branch 130 that switches between a conveyance path for guiding a print sheet to the sheet discharge port 120 and a conveyance path for guiding a print sheet to a downstream unit. A known conveyance switching flapper, which is disposed at the conveyance branch 130, can be driven to switch the conveyance destination of the print sheet.

The print unit 200 prints an image on a print sheet as a recording medium.

As illustrated in FIG. 2B, the print unit 200 includes a print head 201 that ejects ink onto a print sheet to form an image, and a print head cap 202 for protecting the print head 201. Further, the print unit 200 includes a print belt 210 that allows image forming processing by the print head 201 and conveyance processing of a print sheet to be finely synchronously adjusted through hardware Application-Specific Integrated Circuit (ASIC) control, and suction fans 212 that suck from below the print belt 210 to prevent a surface of the belt from undulating. The print belt 210 as a conveyance belt is configured to convey a sheet as a recording medium by suction of the sheet onto the surface of the print belt 210. In the present embodiments, a suction unit 212 (the suction fans) to suck air is provided to generate negative pressure to attract the sheet onto the print belt 210. The print belt 210, which has a plurality of ventilation holes through which air sucked by the suction unit 212 can pass, is configured to attract the sheet onto the print belt 210. The suction unit 212 includes a suction box disposed inside the print belt 210 and the suction fans 212 that suck air from within the suction box. Further, the print unit 200 includes an in-line scanner 220 for reading an image printed on a print sheet.

The fixing unit 300, which is configured to perform fixing control to fix the image printed by the print unit 200 onto a print sheet, uses a plurality of heater units to fix the printed image. As illustrated in FIG. 2B, the fixing unit 300 includes a heater belt 301 and a fixing belt 302, and applies heat, which is finely temperature-controlled through hardware ASIC control, to the print sheet to perform fixing control of ink. Further, similarly to the sheet feeding unit 100, the fixing unit 300 includes a sheet discharge port 320 for temporarily retracting a print sheet.

A cooling unit 400, which is configured to perform temperature adjustment control to cool the print sheet heated by the fixing unit 300 to return the print sheet to room temperature, cools the print sheet using a plurality of fan units. Further, as illustrated in FIG. 2B, the cooling unit 400 includes a conveyance branch 401 that switches using a known flapper between a conveyance path for guiding a print sheet with one surface printed thereon to the print unit 200 again for image forming processing of a two-sided print job and a conveyance path for guiding a print sheet to a downstream unit. When processing the two-sided print job, the image forming apparatus 10 according to the present disclosure conveys a print sheet to the print unit 200 to perform printing on one surface of the print sheet, and then switches the conveyance path at the conveyance branch 401 to convey the print sheet through the fixing unit 300 to the sheet feeding unit 100. Thereafter, the image forming apparatus 10 conveys the print sheet to the print unit 200 again, and performs conveyance control so that image formation on the other surface is performed. The image forming apparatus 10 conveys the print sheet with the other surface printed thereon to the cooling unit 400 through the fixing unit 300 again. When the print sheet reaches the conveyance branch 401, the print sheet is then conveyed to a downstream unit to be placed in the sheet discharge unit 600. Further, similarly to the sheet feeding unit 100, the fixing unit 300 includes the sheet discharge port 320 for temporarily retracting a print sheet.

The reversing unit 500 is configured to perform sheet reversal control of a print sheet conveyed in a switchback manner to switch whether the printed surface of the printed sheet faces upward or downward to place the printed sheet in the subsequent sheet discharge unit 600. As further illustrated in FIG. 2B, the reversing unit 500 includes a sheet discharge port 501 that can be used as a temporary retraction destination for print sheets, and a conveyance branch 502 that uses a known flapper to switch between a conveyance path for guiding the print sheet to the sheet discharge port 501 and a conveyance path for guiding the print sheet to a downstream unit.

The sheet discharge unit 600, which performs sheet discharge control of print sheets subjected to printing to be discharged and stacked, includes a sheet discharge stacker 601 as illustrated in FIG. 2B.

### Movement Mechanism for Print Head and Print Head Cap

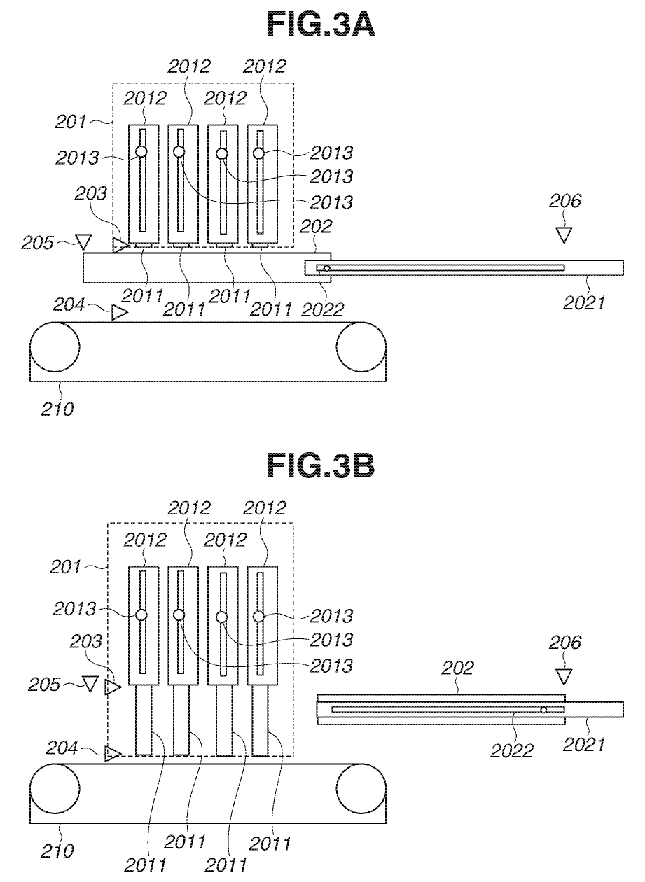

FIGS. 3A and 3B each illustrate an example of a movement mechanism for the print head 201 and the print head cap 202.

FIG. 3A illustrates positions of the print head 201 and the print head cap 202 when printing is not performed. FIG. 3B illustrates positions of the print head 201 and the print head cap 202 during printing.

As illustrated in FIG. 3A, the print head 201 includes head portions 2011 each for the corresponding color, namely, yellow, magenta, cyan, or black. Each head portion 2011 is connected via a print head lifting and lowering mechanism 2013 to a print head storage device 2012 provided for the corresponding color, which is fixed to the print unit 200. Each print head lifting and lowering mechanism 2013 connects the corresponding head portion 2011 and the corresponding print head storage device 2012 via a not-illustrated threaded shaft and a not-illustrated nut. Each print head lifting and lowering mechanism 2013 is configured to rotate the corresponding threaded shaft in forward and reverse directions using a not-illustrated motor, moving the corresponding head portion 2011 in up and down directions. Further, the print head 201 includes a print head retraction position detection sensor 203 and a print head printing position detection sensor 204, both of which detect lower leading end positions of the head portions 2011.

Further, as illustrated in FIG. 3A, the print head cap 202 serving as a protection unit is connected to a print head cap fixing portion 2021 fixed to the print unit 200 via a print head cap slide mechanism 2022. The print head cap slide mechanism 2022 serving as the movement mechanism is configured so that a not-illustrated motor provided with a gear rotates its gear to engage the gear with a not-illustrated slide rack on the print head cap fixing portion 2021, which enables the print head cap slide mechanism 2022 to move in left and right directions. The print head cap 202 includes a print head cap protection position detection sensor 205 and a print head cap release position detection sensor 206, both of which detect the left and right end positions of the print head cap 202.

A method for moving the print head 201 and the print head cap 202 will now be described with reference to FIGS. 3A and 3B.

FIG. 3A illustrates positions of the print head 201 and the print head cap 202 in a non-printing state.

As illustrated in FIG. 3A, the print head 201 in the non-printing state is at a print head retraction position where the head portions 2011 are raised. The print head retraction position is a position where the lower ends of the head portions 2011 are detected by the print head retraction position detection sensor 203. Further, as illustrated in FIG. 3A, the print head cap 202 is moved to a head protection position between the print head 201 and the print belt 210. As a result, the print head 201 is capped and protected. The head protection position is a position where the left end portion of the print head cap 202 is detected by the print head cap protection position detection sensor 205.

FIG. 3B illustrates positions of the print head 201 and the print head cap 202 during printing.

As illustrated in FIG. 3B, the head portions 2011 in a printing state are lowered, and the print head 201 is positioned at a print head printing position (the image forming position) directly above the print belt 210. The print head printing position is a position where the lower ends of the head portions 2011 are detected by the print head printing position detection sensor 204. Further, as illustrated in FIG. 3B, the print head cap 202 has moved from below the print head 201 to a head release position (an exposure position) on the right side. This brings the print head 201 into a state of being released from the cap protection. The head release position is a position where the right end portion of the print head cap 202 is detected by the print head cap release position detection sensor 206.

A method for moving the print head 201 and the print head cap 202 will now be described with reference to FIGS. 3A and 3B.

First, a method for moving the print head 201 in the non-printing state from the print head retraction position to the print head printing position in the printing state will be described.

As illustrated in FIG. 3A, the print head 201 in the non-printing state is covered and protected by the print head cap 202. Thus, to move the print head 201 to the print head printing position illustrated in FIG. 3B, the print head cap 202 is moved from the head protection position illustrated in FIG. 3A to the head release position illustrated in FIG. 3B. When the print head cap 202 reaches the head release position, the head portions 2011 of the print head 201 are lowered, which enables the print head 201 to move to the print head printing position. Next, an operation of each movement mechanism will be described in detail.

An operation of the movement mechanism in the print head 201 will be described.

A method for moving the print head 201 from the print head retraction position illustrated in FIG. 3A to the print head printing position illustrated in FIG. 3B will be described. To move the print head 201 to the print head printing position, the motors in the print head lifting and lowering mechanisms 2013 are driven in the forward direction. The motors are driven to rotate the threaded shafts in the print head lifting and lowering mechanisms 2013 to lower the head portions 2011 from the print head storage devices 2012. Thereafter, in response to detection of the lower ends of the head portions 2011 by the print head printing position detection sensor 204, the motors in the print head lifting and lowering mechanisms 2013 are stopped.

A method for moving the print head 201 from the print head printing position illustrated in FIG. 3B to the print head retraction position illustrated in FIG. 3A will be described. To move the print head 201 to the print head retraction position, the motors in the head lifting and lowering mechanisms 2013 are driven in the reverse direction. The motors are driven to rotate the threaded shafts in the head lifting and lowering mechanisms 2013 to raise the head portions 2011 with respect to the print head storage devices 2012. Thereafter, in response to detection of the lower leading ends of the head portions 2011 by the print head retraction position detection sensor 203, the motors in the print head lifting and lowering mechanisms 2013 are stopped.

The methods described above enable the print head 201 to be moved between the print head retraction position and the print head printing position.

Then, an operation of the movement mechanism for the print head cap 202 will be described.

A method for moving the print head cap 202 from the head protection position illustrated in FIG. 3A to the head release position illustrated in FIG. 3B will be described. To move the print head cap 202 to the head release position, the motor in the print head cap slide mechanism 2022 is driven in the forward direction. The motor is driven to cause the gear to engage with the slide rack on the print head cap slide mechanism 2022 and then to move the print head cap 202 to the right. Thereafter, in response to detection of the right end portion of the print head cap 202 by the print head cap release position detection sensor 206, the motor in the print head cap slide mechanism 2022 is stopped.

A method for moving the print head cap 202 from the head release position illustrated in FIG. 3B to the head protection position illustrated in FIG. 3A will be described. To move the print head cap 202 to the head protection position, the motor in the print head cap slide mechanism 2022 is driven in the reverse direction. The motor is driven to cause the gear to engage with the slide rack on the print head cap slide mechanism 2022 and then to move the print head cap 202 to the left. Thereafter, in response to detection of the left end portion of the print head cap 202 by the print head cap protection position detection sensor 205, the motor of the print head cap slide mechanism 2022 is stopped.

The methods described above enable the print head cap 202 to be moved between the head protection position and the head release position.

Through the methods described above, the print head 201 and the print head cap 202 are moved to designated positions. The movement mechanisms described in the present embodiments are merely examples, and the print head 201 and the print head cap 202 may be moved by other methods.

### Configuration for Door Status Detection and Door Locking of Print Unit

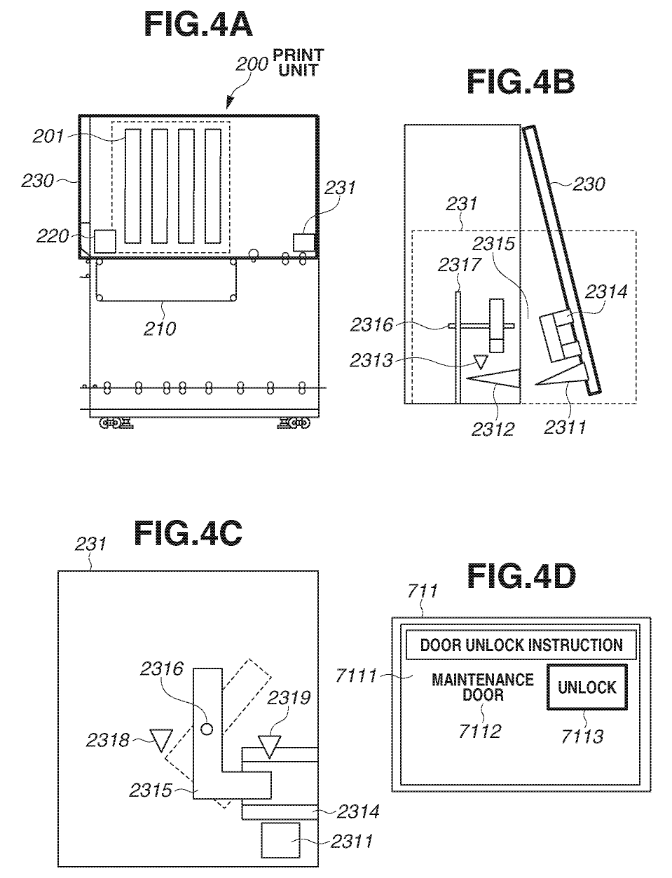

FIGS. 4A, 4B, 4C, and 4D, each illustrate an example of a configuration regarding a maintenance door 230 for removing a print sheet remaining in the print unit 200 due to a conveyance failure, door status detection (detection of opening and closing of a door), and door locking according to the present disclosure. The maintenance door 230 is normally locked in a closed state so that the user cannot touch the print head 201, the print belt 210 that is being driven, and the in-line scanner 220 that reads a printed image. In a case where a print sheet remains in the print unit 200 due to a conveyance failure, the user can unlock and open the maintenance door 230 to remove the remaining print sheet. The structures and the operations will be described in detail with reference to FIGS. 4A - 4D.

FIG. 4A is a front view of the print unit 200. FIG. 4B is a left cross-sectional view of the maintenance door 230 and the print unit 200 covered by the maintenance door 230 as viewed from the left at a door lock unit 231 illustrated in FIG. 4A. FIG. 4C is a detailed view of the door lock unit 231 as viewed from the front. FIG. 4D is a UI screen, on the print server 70, used to request unlocking of the maintenance door 230.

FIG. 4A illustrates configurations of the print unit 200 and the maintenance door 230. The print head 201, the print belt 210 that is being driven, and the in-line scanner 220 that reads a printed image are protected with the maintenance door 230 so that the user cannot touch the print head 201, the print belt 210, and the in-line scanner 220. Further, not-illustrated hinges are attached to the upper portion of the maintenance door 230, which allows the maintenance door 230 to be opened upward using the upper surface as a fulcrum. With the maintenance door 230 closed, the maintenance door 230 is locked by the door lock unit 231 so that the user cannot open the maintenance door 230. The door lock unit 231 is capable of detecting the open state and the closed state of the maintenance door 230 and locking the maintenance door 230. In this manner, the door lock unit 231 locking the maintenance door 230 with the maintenance door 230 closed during printing makes it possible to prevent the user from touching the print head 201, the print belt 210, and the in-line scanner 220.

Door status detection and door locking by the door lock unit 231 will be described with reference to FIGS. 4B and 4C. FIG. 4B is a cross-sectional view taken at a plane of the door lock unit 231 from the left side of the print unit 200 with the maintenance door 230 open. FIG. 4C is a front view of the door lock unit 231.

The configuration for door status detection by the door lock unit 231 will be described with reference to FIG. 4B. As illustrated in FIG. 4B, the door lock unit 231 includes a status detection protrusion 2311 and a status detection recess 2312 for performing door status detection. Further, the door lock unit 231 includes a door status detection sensor 2313 as a detection unit, which detects the end of the status detection protrusion 2311.

Next, the configuration for the door locking by the door lock unit 231 will be described with reference to FIGS. 4B and 4C. As illustrated in FIG. 4B, the door lock unit 231 as a restricting unit includes a door lock portion 2314 on the maintenance door 230 and a door lock insertion portion 2315 in the print unit 200 for door locking. The door lock insertion portion 2315 is connected to a door lock insertion portion rotation shaft 2316 that is fixed to the print unit 200 using a door lock fixing portion 2317. Rotating the door lock insertion portion rotation shaft 2316 by a not-illustrated motor causes the door lock insertion portion 2315 to be rotated in conjunction with the door lock insertion portion rotation shaft 2316. The door lock insertion portion 2315 is rotated so that the door lock insertion portion 2315 can be moved between a door lock position (a restricting position) indicated by solid lines and a door unlock position (an allowing position) indicated by dashed lines, both of which are illustrated in FIG. 4C. Thus, the door lock insertion portion 2315 is configured to be movable between the restricting position at which the movement of the maintenance door 230 from the closed position to the open position is restricted and the allowing position at which the movement from the closed position to the open position is allowed. Further, as illustrated in FIG. 4C, the door lock unit 231 includes a door unlock detection sensor 2318 for detecting the left end portion of the door lock insertion portion 2315 and a door lock detection sensor 2319 for detecting the right end portion of the door lock insertion portion 2315.

Then, methods of door detection and door locking by the door lock unit 231 will now be described with reference to FIGS. 4B and 4C.

First, a door detection method using the door lock unit 231 will be described. As illustrated in FIG. 4B, with the maintenance door 230 open, the status detection protrusion 2311 is separated from the status detection recess 2312. As a result, the door status detection sensor 2313 does not detect the end of the status detection protrusion 2311. Thus, the maintenance door 230 is in the open state. Next, although not illustrated, when the maintenance door 230 is closed, the status detection protrusion 2311 is inserted into the status detection recess 2312. As a result, the door status detection sensor 2313 detects the end of the status detection protrusion 2311, and the maintenance door 230 is in the closed state.

The method described above enables the door lock unit 231 to detect the open state and the closed state of the maintenance door 230.

A door locking method using the door lock unit 231 will be described. With the maintenance door 230 closed, door locking is enabled when the door lock insertion portion 2315 is moved between the door lock position indicated by the solid lines in FIG. 4C and the door unlock position indicated by the dashed lines in FIG. 4C.

First, a method will be described of moving the door lock insertion portion 2315 from the door unlock position indicated by the dashed lines in FIG. 4C to the door lock position indicated by the solid lines in FIG. 4C. In response to a door lock instruction being received, a not-illustrated motor drives the door lock insertion portion rotation shaft 2316 to rotate in the forward direction, causing the door lock insertion portion 2315 to be rotated counterclockwise about the door lock insertion portion rotation shaft 2316. In response to detection of the right end portion of the door lock insertion portion 2315 by the door lock detection sensor 2319, it is determined that the door lock insertion portion 2315 has reached the door lock position indicated by the solid lines in FIG. 4C, and the driving of the motor, which is not illustrated, is stopped. At this door lock position, the door lock insertion portion 2315 interferes with the door lock portion 2314, preventing the maintenance door 230 from being opened.

Next, a method will be described of moving the door lock insertion portion 2315 from the door lock position indicated by the solid lines in FIG. 4C to the door unlock position indicated by the dashed lines in FIG. 4C. In response to a door unlock instruction being received, a not-illustrated motor drives the door lock insertion portion rotation shaft 2316 to rotate in the reverse direction, causing the door lock insertion portion 2315 to be rotated clockwise about the door lock insertion portion rotation shaft 2316. In response to detection of the left end portion of the door lock insertion portion 2315 by the door unlock detection sensor 2318, it is determined that the door lock insertion portion 2315 has reached the door unlock position indicated by the dashed lines in FIG. 4C, and the driving of the motor, which is not illustrated, is stopped. At this door unlock position, the door lock insertion portion 2315 does not interfere with the door lock portion 2314, allowing the maintenance door 230 to be opened.

A method by which the user requests the unlocking of the maintenance door 230 will now be described with reference to FIG. 4D.

First, a configuration of a UI screen for requesting door unlocking will be described with reference to FIG. 4D. The print server operation unit 71 includes a UI screen 711 used to issue an instruction to change various settings, an instruction to perform printing, and the like. On the UI screen 711, a door unlock screen 7111 is provided that allows the user to issue an instruction to perform door unlocking to the image forming apparatus 10. The door unlock screen 7111 includes an unlock target door display section 7112 and a door unlock button 7113.

Next, a method by which the user issues an instruction to perform door unlocking via the print server operation unit 71 will be described with reference to FIG. 4D. To perform door unlocking, the user selects an item for the door unlock screen 7111 on the UI screen 711. In response to the item for the door unlock screen 7111 being selected, the door unlock screen 7111 is displayed, and a locked door is displayed in the unlock target door display section 7112. By the user pressing the door unlock button 7113, a door unlock request is notified to the image forming apparatus 10. In response to the door unlock request being received, the door lock unit 231 performs the door unlocking through the above-described method. The method described above allows the maintenance door 230 to be unlocked.

The configuration described above enables door status detection and door locking. However, the door status detection method, the door lock mechanism, and the door unlock method described above are merely examples, and the door status detection and the door locking may be performed by other methods.

### Operation at Conveyance Failure Occurs

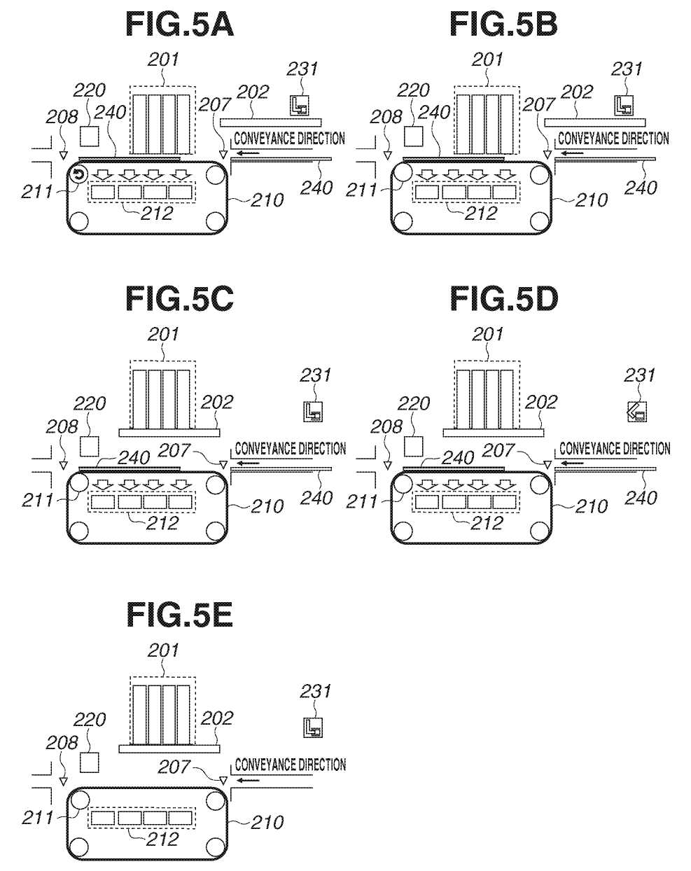

FIGS. 5A, 5B, 5C, 5D, and 5E, are views each illustrating an operation of the print head 201, the print belt 210, the suction fans 212, and the door lock unit 231 when a conveyance failure occurs during printing and a print sheet remains on the print belt 210 according to the present disclosure. FIG. 5A is a view illustrating a state during printing. FIG. 5B is a view illustrating a state in which the conveyance failure occurs during printing and a printing operation is stopped. FIG. 5C is a view illustrating a state in which the print head 201 is protected by the print head cap 202 after the occurrence of the conveyance failure during printing. FIG. 5D is a view illustrating a state in which the door lock unit 231 is unlocked after the protection of the print head 201 by the print head cap 202. FIG. 5E is a view illustrating a state in which the user removes the unfixed sheet, the door closed state of the door lock unit 231 is detected, and the door is locked.

First, a configuration based on the assumption for describing an operation at the time of occurrence of the conveyance failure will be described with reference to FIG. 5A, which illustrates the state during printing. The print unit 200 includes the print head 201 for printing an image on a print sheet 240, and the print head cap 202 for protecting the print head 201. The print unit 200 also includes the print belt 210 for conveying the print sheet 240 from the sheet feeding unit 100 on the upstream side to the fixing unit 300 on the downstream side. Further, the print unit 200 includes a print belt inlet sensor 207 and a print belt outlet sensor 208, both of which detect the presence of the print sheet 240 on the print belt 210. The print belt 210 includes a driving roller 211 driven by a not-illustrated motor, and the suction fans 212 for sucking the print belt 210 and the print sheet 240. Further, the print unit 200 includes the in-line scanner 220 for reading an image formed on the print sheet 240 above the print belt 210 downstream of the print head 201. The print unit 200 also includes the door lock unit 231 for preventing the user from opening the maintenance door 230 during printing, and for allowing the user to open the maintenance door 230 to remove the print sheet 240 remaining at the time of occurrence of a conveyance failure.

An operation from occurrence of a conveyance failure during printing to stoppage of the suction fans 212 will now be described with reference to FIGS. 5A - 5E.

First, an operation in a state during printing will be described with reference to FIG. 5A. During printing, the print head 201 is moved to the print head printing position and the print head cap 202 is moved to the head release position by the movement mechanisms described above with reference to FIGS. 3A and 3B. Further, the above-described door lock unit 231 locks the maintenance door 230 so that the user cannot touch the print head 201, the print belt 210, and the in-line scanner 220. The print belt 210 is rotated by the driving roller 211 that is rotated by a not-illustrated driving motor, and is sucked by the suction fans 212 so as to attract the print sheet 240 onto the print belt 210 from below.

In response to the start of printing, the print sheet 240 is conveyed from the sheet feeding unit 100 on the upstream side. When the leading end of the print sheet 240 is detected by the print belt inlet sensor 207, the CPU 1001 determines that a sheet is present on the print belt 210. In response to detection of the leading end of the print sheet 240 by the print belt inlet sensor 207, the head control unit 1010 operates the print head 201 to form an image on the print sheet 240 at a timing when the print sheet 240 reaches a region below the print head 201. Subsequently, when the print sheet 240 with the image formed thereon reaches the in-line scanner 220, the in-line scanner 220 reads the image formed on the print sheet 240. The result read by the in-line scanner 220 is analyzed by the CPU 1001, and the analyzed result is reflected in control of the head control unit 1010, reducing degradation in image quality. Thereafter, in response to detection of the trailing end of the print sheet 240 by the print belt outlet sensor 208, the CPU 1001 determines that no sheet is present on the print belt 210.

Subsequently, the image is fixed to the print sheet 240 by the fixing unit 300 on the downstream side. In FIG. 5A, since the print belt outlet sensor 208 does not detect the trailing end of the print sheet 240, the CPU 1001 determines that the print sheet 240 is present on the print belt 210.

By the operation described above, the image is formed on the print sheet 240.

Next, a state will be described in which a conveyance failure occurs during printing described with reference to FIG. 5A, and an unfixed sheet, which is the unfixed print sheet 240, remains on the print belt 210 with reference to FIG. 5B.

As illustrated in FIG. 5B, in a case where a conveyance failure occurs during printing, the driving roller 211 is stopped to stop the print belt 210. The print sheet 240 as the unfixed sheet remains on the print belt 210. While the print belt 210 is in a stopped state, the suction fans 212 are not stopped in order to prevent the unfixed sheet on the print belt 210 from lifting and coming in contact with the print head 201 or the in-line scanner 220, preventing contamination inside the image forming apparatus 10. Further, the door lock unit 231 keeps the maintenance door 230 locked to prevent the user from touching the print head 201.

Then, when the print belt 210 is stopped as illustrated in FIG. 5B, the protection of the print head 201 is performed. This state will be described with reference to FIG. 5C.

As illustrated in FIG. 5C, the movement mechanisms for the print head 201 and the print head cap 202 described above move the print head 201 to the print head retraction position and the print head cap 202 to the head protection position, protecting the print head 201. Meanwhile, since the print sheet 240 as the unfixed sheet is not removed from the print belt 210, the suction fans 212 are not stopped and continue operating to keep the sheet attracted onto the print belt 210.

Further, with a door unlock instruction not received, the door lock unit 231 keeps the maintenance door 230 locked.

Subsequently, to remove the remaining unfixed sheet, the user releases the door lock by the method described with reference to FIG. 4D. A state at that time is illustrated in FIG. 5D.

As illustrated in FIG. 5D, when the door unlock is performed, the door lock unit 231 unlocks the maintenance door 230. This allows the user to open the maintenance door 230 and remove the print sheet 240 as the remaining unfixed sheet. Meanwhile, since the unfixed sheet remains on the print belt 210, the suction fans 212 are not stopped.

Next, FIG. 5E illustrates a state in which the maintenance door 230 is closed with the remaining unfixed sheet removed.

As illustrated in FIG. 5E, the door lock unit 231 locks the maintenance door 230 again in response to detecting the state where the door is closed. Further, based on the change in the door state from open to closed detected by the door lock unit 231, it is determined that the unfixed sheet is removed from the print belt 210, which causes the suction fans 212 to be stopped. In the present embodiments, it is determined that the remaining unfixed sheet is removed from the print belt 210 based on the change in the door status detected by the door lock unit 231. However, the detection may be performed by another method. For example, there is a method in which if the print belt outlet sensor 208 does not detect the print sheet 240 for a predetermined period of time during which the print belt 210 is driven, it is determined that the print sheet 240 does not remain on the print belt 210.

As described above, in a case where the conveyance failure occurs during printing, the suction fans 212 are not stopped until the unfixed sheet remaining on the print belt 210 is removed, preventing contamination inside the image forming apparatus 10.

### Description of Operational Flowchart According to First Embodiment

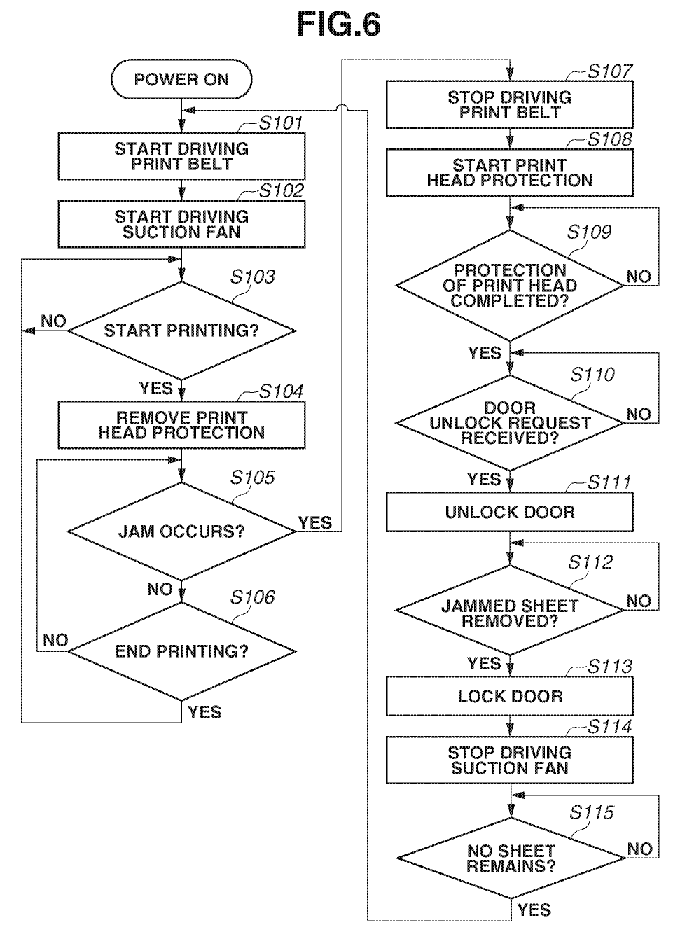

Operations from start-up to printing of the image forming apparatus 10 and an operation of the image forming apparatus 10 at the time of a conveyance failure according to the first embodiment will now be described with reference to a flowchart illustrated in FIG. 6. This procedure is performed by the CPU 1001 in response to the image forming apparatus 10 being powered on.

In step S101, in response to the image forming apparatus 10 being powered on, the CPU 1001 starts the driving of the print belt 210, and the processing proceeds to step S102.

In step S102, the CPU 1001 starts the driving of the suction fans 212 to start applying suction to the print belt 210, and the image forming apparatus 10 transitions to a standby state. The processing then proceeds to step S103.

In step S103, the CPU 1001 determines whether the image forming apparatus 10 has received a job from the network 1006. If the CPU 1001 determines that the image forming apparatus 10 has received a job (YES in step S103), the image forming apparatus 10 transitions to a printing state. The processing then proceeds to step S104. If the CPU 1001 determines that the image forming apparatus 10 has not received a job (NO in step S103), the image forming apparatus 10 remains in the standby state until the image forming apparatus 10 receives a job.

In step S104, the CPU 1001 moves the print head cap 202 to the head release position using the above-described method to move the print head 201 to the print head printing position. The processing then proceeds to step S105.

In step S105, the CPU 1001 monitors the print belt inlet sensor 207 and the print belt outlet sensor 208 as conveyance sensors. The CPU 1001 calculates an expected time for the leading end of the print sheet 240 to reach the print belt inlet sensor 207 at a timing when the print sheet 240 is discharged from the sheet feeding unit 100 on the upstream side. If the print belt inlet sensor 207 does not detect the print sheet 240 within the calculated time, the CPU 1001 determines that a conveyance failure occurs. Further, the CPU 1001 calculates an expected time for the trailing end of the print sheet 240 to reach the print belt outlet sensor 208 based on a timing when the trailing end of the print sheet 240 is detected using the print belt inlet sensor 207. If the print sheet 240 is not detected by the print belt outlet sensor 208 within the calculated time, the CPU 1001 also determines that a conveyance failure occurs. The expected time until the print sheet 240 reaches a conveyance sensor is calculated using the conveyance speed of the print sheet 240 and the conveyance distance.

If a conveyance failure is detected (YES in step S105), the processing proceeds to step S107. If no conveyance failure is detected (NO in step S105), the processing proceeds to step S106.

In step S106, the CPU 1001 detects whether the job is completed. If the job is completed (YES in step S106), the image forming apparatus 10 transitions to the stand-by state. The processing then proceeds to step S103 in which the CPU 1001 waits for the start of a job again. If the job is not completed (NO in step S106), the processing proceeds to step S105. In step S105, the CPU 1001 performs jam detection. The state illustrated in FIG. 5A described above represents a state at a timing from step S104 to step S106.

If a conveyance failure occurs (YES in step S105), the process proceeds to step S107. In step S107, the CPU 1001 stops the print belt 210. The processing then proceeds to step S108. At this time, in order to prevent the unfixed sheet remaining on the print belt 210 from lifting from the print belt 210, the suction fans 212 continue suction without being stopped. The state illustrated in FIG. 5B described above represents a state at the timing of step S107.

In step S108, the CPU 1001 moves the print head 201 to the print head retraction position and the print head cap 202 to the head protection position to start protecting the print head 201. The processing then proceeds to step S109.

In step S109, the CPU 1001 monitors whether the protection operation of the print head 201 using the print head cap 202 is completed. If the protection operation is completed (YES in step S109), the processing proceeds to step S110. If the protection operation is not completed (NO in step S109), the image forming apparatus 10 remains in the state described in step S109 until the protection operation is completed. The state illustrated in FIG. 5C described above represents a state at the timing when the protection operation is completed in step S109.

In step S110, to remove the unfixed sheet on the print belt 210, the CPU 1001 monitors whether an unlocking of the maintenance door 230 is requested by the user using the method described with reference to FIG. 4D. If the request for unlocking is notified (YES in step S110), the processing proceeds to step S111. If the request for unlocking is not notified (NO in step S110), the image forming apparatus 10 remains in the state described in step S110 until the request for unlocking is notified. At this timing, the movement of the print head 201 to the print head retraction position and the movement of the print head cap 202 to the head protection position are completed. Further, the driving of the print belt 210 is stopped. Meanwhile, the suction fans 212 continue the suction to prevent the unfixed sheet on the print belt 210 from lifting. The reason the suction is continued even after the completion of the head protection operation is to prevent the unfixed sheet from lifting and contamination the inside of the image forming apparatus 10. In particular, since the in-line scanner 220 is disposed downstream of the print belt 210, contact of the unfixed sheet with the in-line scanner 220 may contaminate the scanner and prevent accurate image reading, and thus, the protection operation is performed. If a configuration is employed in which the in-line scanner 220 moves to a retraction position similarly to the print head 201, or in which the in-line scanner 220 is protected from contamination, the suction fans 212 may be stopped at this timing.

In step S111, the CPU 1001 unlocks the maintenance door 230 using the door lock unit 231 so that the user can open the maintenance door 230 to remove the unfixed sheet. (In the present embodiment, the CPU 1001 may prohibit unlocking by the door lock unit 231 until the movement of the print head 201 to the print head retraction position and the movement of the print head cap 202 to the head protection position are completed.) The processing then proceeds to step S112. When the maintenance door 230 is unlocked, the user can open the maintenance door 230 to remove the unfixed sheet or any remaining print sheet. The state illustrated in FIG. 5D described above represents a state at the timing when the door unlocking is performed in step S111.

In step S112, the CPU 1001 monitors whether the state of the door is changed from the open state to the closed state using the door lock unit 231. As described with reference to FIGS. 4A - 4D, if a transition from the open state to the closed state is detected, the CPU 1001 determines that no print sheet remains on the print belt 210 (YES in step S112), and the processing proceeds to step S113. If a transition from the open state to the closed state is not detected, the CPU 1001 determines that the print sheet remains on the print belt 210 (NO in step S112), and the image forming apparatus 10 remains in the state in step S112. Thus, the CPU 1001 continues the driving of the suction fans 212 based on a detection result from the door status detection sensor 2313 in the door lock unit 231 until the transition from the open state to the closed state is detected.

In step S113, the CPU 1001 locks the maintenance door 230 using the door lock unit 231, and the processing proceeds to step S114.

In step S114, the CPU 1001 stops the driving of the suction fans 212 to stop the suction, and the processing proceeds to step S115. Thus, if the transition from the open state to the closed state is detected based on a detection result from the door status detection sensor 2313 in the door lock unit 231, the CPU 1001 stops the driving of the suction fans 212. At this timing, since the unfixed sheet is removed from the print belt 210, the CPU 1001 determines that the print sheet that could contaminate the inside of the image forming apparatus 10 is removed, and stops the suction by the suction fans 212. The state illustrated in FIG. 5E described above represents a state at the timing of step S114.

In step S115, the CPU 1001 monitors whether no print sheet remains in other units. If no print sheet remains in all the units (YES in step S115), the processing proceeds to step S101, and the image forming apparatus 10 operates to transition to the standby state. If the print sheet remains (NO in step S115), the image forming apparatus 10 remains in the state described in step S115.

By performing the procedure described above, even in a case where an unfixed sheet remains on the print belt 210 due to a conveyance failure occurrence during printing, the unfixed sheet can be removed without being lifted.

The above-described embodiments of the present disclosure can prevent contamination of the inside of the image forming apparatus 10 due to lifting of a print sheet with an image unfixed thereto on the print belt 210 at a conveyance failure.

Further, in the present embodiments, the suction fans 212 are stopped after a print sheet remaining due to a conveyance failure is removed. However, in a case where the in-line scanner 220 and other units inside the image forming apparatus 10 are protected at a timing when the protection operation of the print head 201 in step S110 is completed so that the in-line scanner 220 and other units are not susceptible to contact with the unfixed sheet, the suction fans 212 may be stopped at that timing. This makes it possible to stop the suction fans 212 earlier whereas contamination of the inside of the image forming apparatus 10 is prevented, reducing the power consumption.

Thus, the present disclosure makes it possible to provide an image forming apparatus capable of reducing unnecessary power consumption whereas an unfixed sheet is prevented from lifting from the print belt at the time of jam processing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-077644, filed May 7, 2025, which is hereby incorporated by reference herein in its entirety.

What is claimed is:

1. An image forming apparatus comprising:
a conveyance belt configured to convey a recording material while sucking;
a head provided to face the conveyance belt and configured to eject ink to the recording material being conveyed by the conveyance belt to form an image;
a suction unit provided inside the conveyance belt and configured to suck air to attract the recording material onto a surface of the conveyance belt;
a door configured to, in a case where the recording material remains on the surface of the conveyance belt due to a conveyance jam, be opened and closed for the recording material remaining on the surface of the conveyance belt to be removed;
a detection unit configured to detect opening and closing of the door; and
a control unit configured to control driving of the suction unit,
wherein in a case where driving of the conveyance belt is stopped due to occurrence of the conveyance jam, the control unit controls the driving of the suction unit based on a detection result from the detection unit so as to:
continue the driving of the suction unit until the door is transitioned from an open state to a closed state; and
stop the driving of the suction unit in a case where the door is transitioned from the open state to the closed state.

2. The image forming apparatus according to claim 1, further comprising a movement mechanism configured to move the head between an image forming position where the head is positioned during forming an image on the recording material and a retraction position where the head is retracted from the conveyance belt,
wherein in a case where the conveyance jam occurs, the control unit controls the movement mechanism to move the head from the image forming position to the retraction position.

3. The image forming apparatus according to claim 2, further comprising a restricting unit movable between a restricting position to restrict movement of the door from a closed position to an open position and an allowing position to allow the movement of the door from the closed position to the open position,
wherein in the case where the conveyance jam occurs, the control unit controls a position of the restricting unit so as to:
position the restricting unit at the restricting position until the head moves from the image forming position to the retraction position; and
allow the restricting unit to move to the allowing position after the head moves from the image forming position to the retraction position.

4. The image forming apparatus according to claim 3, further comprising a protection unit movable between a protection position where the head is covered and an exposure position where the head is exposed, and configured to protect the head,
wherein, in the case where the conveyance jam occurs, the control unit controls:
a position of the protection unit so as to move the protection unit from the exposure position to the protection position after the movement mechanism moves the head from the image forming position to the retraction position; and
the position of the restricting unit so as to:
position the restricting unit at the restricting position until the protection unit moves from the exposure position to the protection position; and
allow the restricting unit to move to the allowing position after the protection unit moves from the exposure position to the protection position.
